(19) United States
(12) Patent Application Publication
(10) Pub. No.: US 2004/0014949 A1
(43) Pub. Date: Jan. 22, 2004

(54) Sequential detection ion chromatography

(76) Inventors: Purnendu K. Dasgupta, Lubbock, TX (US); Rebecca L. Adams, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/363,926

(22) PCT Filed: Sep. 4, 2001
(86) PCT No.: PCT/US01/27499

(30) Foreign Application Priority Data
Sep. 8, 2000 (US) 60231086

(51) Int. Cl. C07K 1/16

(52) U.S. Cl. 530/417

(57) ABSTRACT

Packings or equivalent structures which produce radial mixing in channels can be used to enhance reagent addition devices for ion chromatography post column reactions in which band spreading at detrimental levels is effectively controlled. Application to two dimensional conductometric detection in simultaneous suppressed and nonsuppressed ion chromatography.

The instant invention is in the field chemical analysis by liquid chromatography. More specifically, the instant invention is in the field of Ion Chromatography.

The chemical analysis technique known as “Ion Chromatography” (IC) was first published in 1975 by Small, Stevens and Bauman (Analytical Chemistry, 1975, pages 1801-1809). Since 1975 IC has become a leading technology for the determination of common anions such as chloride and sulfate.

Anions can be determined by IC by injecting a sample into an eluant of dilute sodium hydroxide flowed through an anion exchange chromatography analytical column, separating the anions of interest of the injected sample in the analytical column by ion exchange chromatography, flowing the effluent stream from the analytical column through a “suppressor” and then through an electrical conductivity detector. The suppressor converts the sodium hydroxide of the effluent stream into water by exchanging the sodium ion for hydrogen ion. The suppressor also converts the separated anions of interest into their acid form, for example., chloride ion is converted into hydrochloric acid. The conductivity detector detects the separated anions as an acid moiety in a background of water. Water has a relatively low conductance. The acid moiety of many common anions dissolved in water has a relatively high conductance. Therefore, IC is a sensitive technique for determining many common anions.

The above described IC system does not, however, provide a sensitive technique for the determination of anions that form a weak acid moiety (pKa greater than about 6) because a weak acid dissolved in water has a relatively low conductance. Examples of such weak acid anions include carbonate and sulfite.

In 1993 Berglund, Dasgupta, Lopez and Nara (Analytical Chemistry, 1993, pages 1192-1198, herein fully described as a modified IC system that provided a sensitive technique for the determination of anions that form a weak acid moiety (up to a pKa of about 10). The modification comprised continuously adding a small amount of a base to the stream flowing from the conductivity detector to form a base treated stream that was then passed through a second conductivity detector.

The base added to the stream from the first conductivity detector reacted with the acid moiety of the separated anions to produce a salt moiety of the separated anions with a corresponding reduction in the concentration of the added base in the region of the separated anions. The added base has a relatively higher conductance than the salt moiety of the separated anions and the concentration of the added base is reduced in the region of the separated anions. Therefore, the second conductivity detector detected the separated anions as negative peaks on an elevated baseline conductance of the added base.

The base was added to the stream from the first conductivity detector by diffusion across a porous membrane, by direct flowing introduction, by Donnan prohibited diffusion across a cation exchange membrane and by the use of a microelectrodialytic base generator (See Strong, Dasgupta, Freidman and Stillian, Analytical Chemistry, 1991, pages 480-486, herein fully incorportated by reference, for additional discussion of the microelectrodialytic base generator). The porous membrane, the direct flowing introduction and the Donnan prohibited diffusion techniques all exhibited significantly poorer signal to noise ratio for separated anions at the second conductivity detector than the use of the microelectrodialytic base generator. Therefore, the use of the microelectrodialytic base generator was preferred.

In the above described modified IC system the baseline noise level of the first conductivity detector is significantly better than the baseline noise level of the second detector because the baseline conductivity of the first conductivity detector is much lower than the elevated baseline of the second conductivity detector. Therefore, the sensitivity of detection by the second conductivity detector of anions that form a weak acid moiety tends to be less than the sensitivity of detection by the first conductivity detector of anions that form a strong acid moiety.

The above described modified IC system of Berglund, Dasgupta, Lopez and Nara, herein defined as “Sequential Detection Ion Chromatography” (SDIC), was a significant advance in IC art. However, it would be a further advance in the IC art if a means could be discovered to yet further decrease the baseline noise level of the second conductivity detector so that the sensitivity of detection by the second conductivity detector of anions that form a weak acid moiety would be better and more like the sensitivity of detection by the first conductivity detector of anions that form a strong acid moiety.

The instant invention provides a means to further decrease the baseline noise level of the second conductivity detector in SDIC so that the sensitivity of detection by the second conductivity detector of anions that form a weak acid moiety is better and more like the sensitivity of detection by the first conductivity detector of anions that form a strong acid moiety. In a related embodiment, the instant invention provides the same benefits for the analysis of cations by SDIC.

In one embodiment, the instant invention is a chemical analysis method for determining anions of interest in a sample to be analyzed, comprising the steps of: separating the anions of interest by anion exchange chromatography using a basic eluant to produce a stream of separated anions in the eluant; exchanging the cations of the stream of separated anions for hydrogen ion to produce a suppressed eluant stream; adding base to the suppressed eluant stream to produce a base treated suppressed eluant stream; mixing the base treated suppressed eluant stream; determining the electrical conductivity of the base treated suppressed eluant stream to determine the separated anions as a negative electrical conductivity response from a baseline response of the base treated suppressed eluant stream. The electrical conductivity of the suppressed eluant stream can also be determined to determine the separated anions as a positive electrical conductivity response from a baseline response of the suppressed eluant stream.

In another embodiment, the instant invention is a chemical analysis method for determining cations of interest in a sample to be analyzed, comprising the steps of: separating the cations of interest by cation exchange chromatography using an acidic eluant to produce a stream of separated cations in the eluant; exchanging the anions of the stream of separated cations for hydroxide ion to produce a suppressed eluant stream; adding acid to the suppressed eluant stream to produce an acid treated suppressed eluant stream; mixing the acid treated suppressed eluant stream; determining the electrical conductivity of the acid treated suppressed eluant stream to determine the separated cations as a negative electrical conductivity response from a baseline response of the acid treated suppressed eluant stream. The electrical conductivity of the suppressed eluant stream can also be determined to determine the separated cations as a positive electrical conductivity response from a baseline response of the suppressed eluant stream.

In another embodiment, the instant invention is an apparatus for the chemical analysis of anions of interest in a sample to be analyzed, comprising: an anion exchange chromatography column; an ion chromatography suppressor in fluid communication with the anion exchange chromatography column; a base addition device in fluid communication with the ion chromatography suppressor; a mixer in fluid communication with the base addition device; an electrical conductivity detector in fluid communication with the mixer. The apparatus can further include an additional electrical conductivity detector in fluid communication with the ion chromatography suppressor and the base addition device.

In another embodiment, the instant invention is an apparatus for the chemical analysis of cations of interest in a sample to be analyzed, comprising: a cation exchange chromatography column; an ion chromatography suppressor in fluid communication with the anion exchange chromatography column; an acid addition device in fluid communication with the ion chromatography suppressor; a mixer in fluid communication with the acid addition device; an electrical conductivity detector in fluid communication with the mixer. The apparatus can further include an additional electrical conductivity detector in fluid communication with the ion chromatography suppressor and the acid addition device.

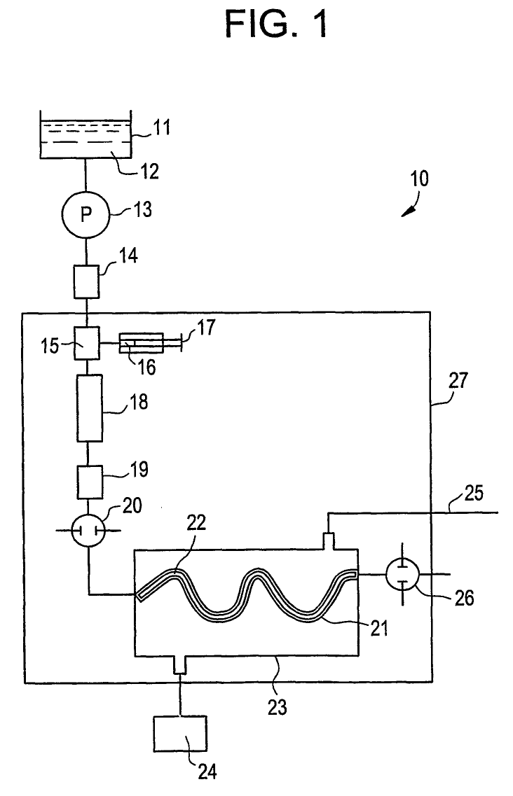

FIG. 1 is schematic drawing of a preferred apparatus for the determination of anions;

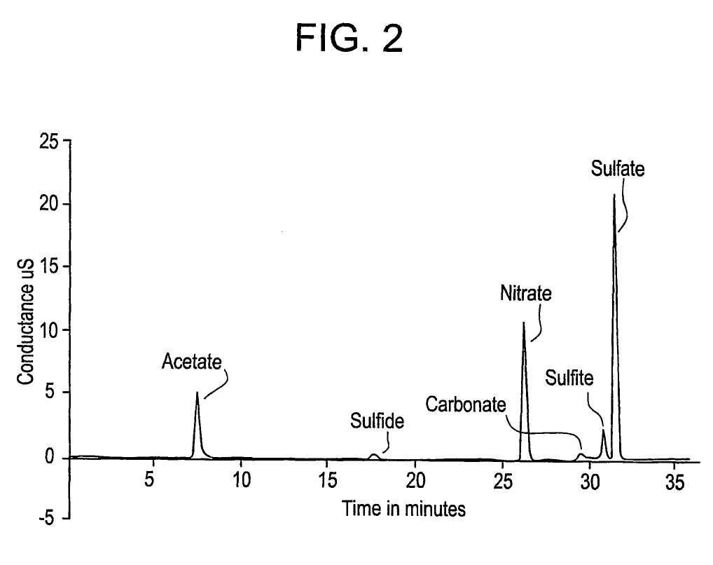

FIG. 2 is a chromatogram showing the separation of anions as detected in the suppressed eluant;

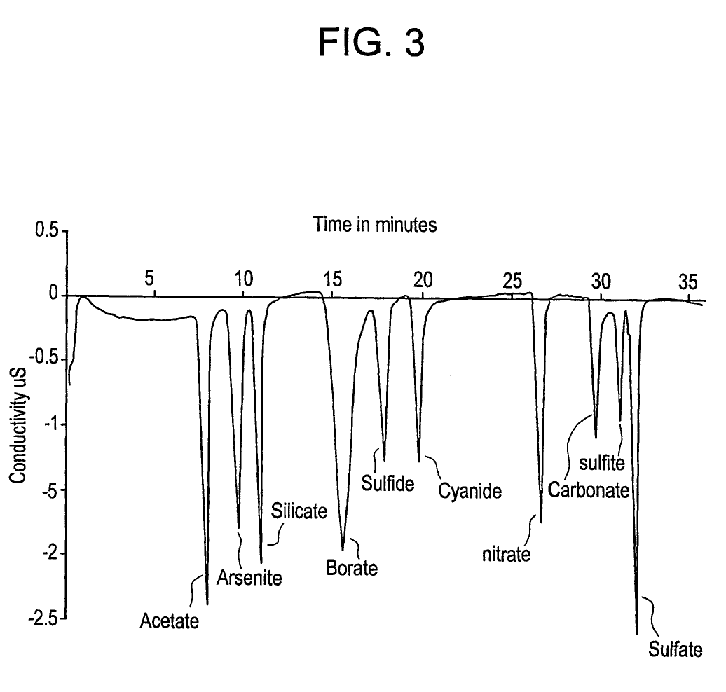

FIG. 3 is a chromatogram showing the separation of anions as detected in the base treated suppressed eluant;

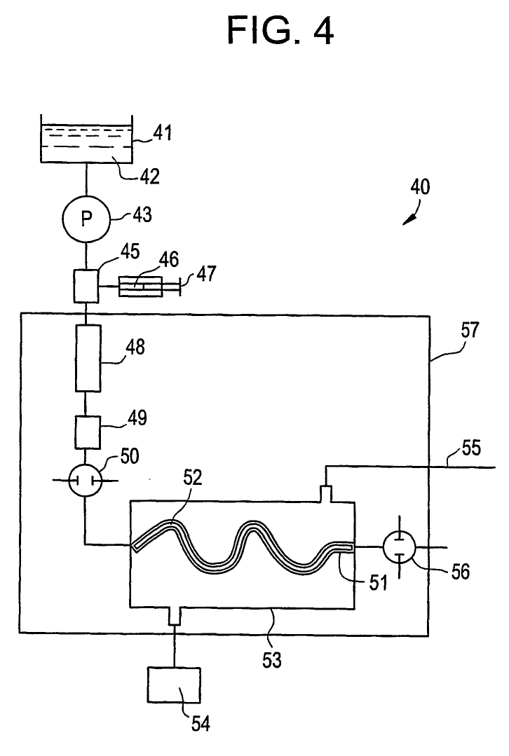

FIG. 4 is a schematic view of a preferred apparatus for the determination of cations;

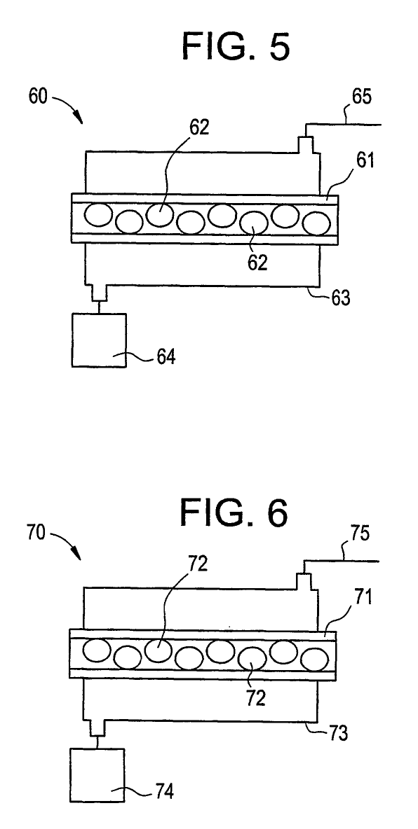

FIG. 5 is a schematic drawing of a base addition device using a plurality of particles as a mixer;

FIG. 6 is a schematic drawing of an acid addition device using a plurality of particles as a mixer;

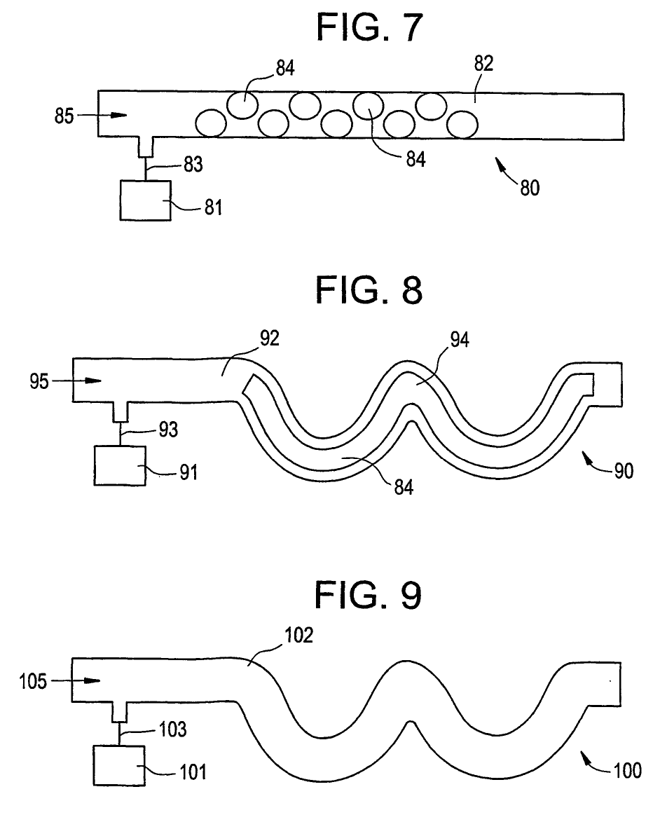

FIG. 7 is a schematic drawing of an acid or base addition device followed by the use of a plurality of particles as a mixer;

FIG. 8 is a schematic drawing of an acid or base addition device followed by the use of a filament filled helical channel as a mixer;

FIG. 9 is a schematic drawing of an acid or base addition device followed by the use of a configured tube as a mixer;

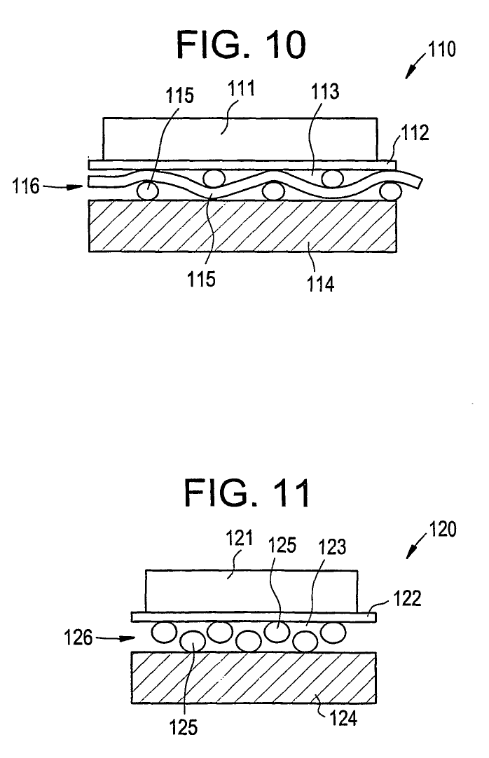

FIG. 10 is a schematic drawing of an acid or base addition device having a screen adjacent an acid or base permeable membrane; and

FIG. 11 is a schematic drawing of an acid or base addition device having a plurality of particles adjacent an acid or base permeable membrane.

Referring now to FIG. 1, therein is shown a preferred apparatus 10 for the determination of anions of interest in a sample to be analyzed. The apparatus 10 includes a reservoir 11 containing deionized water 12. The reservoir 11 is in fluid communication with a liquid chromatography pump 13 which pumps water 12 to a microelectrodialytic base generator 14. The microelectrodialytic base generator 14 adds a continuous amount of base to the pumped stream of water 12 converting it into a basic eluant that is flowed through a sample injection valve 15. A sample 16 containing anions of interest is contained in syringe 17 to be injected into the basic eluant by the injection valve 15. The anions of interest are separated by anion exchange chromatography on anion exchange chromatography column 18. An ion chromatography suppressor 19 exchanges the cataions of the stream of separated anions from the column 18 for hydrogen ion to produce a suppressed eluant stream that is flowed through a first electrical conductivity detector 20. The first electrical conductivity detector 20 determines the separated anions as a positive response from a baseline response of the suppressed eluant stream as shown in FIG. 2.

Referring again to FIG. 1, the stream of suppressed eluant from the first conductivity detector 20 is then flowed through a coiled helix of tubular cation exchange membrane 21 (NAFION brand cation exchange tubing). The coiled helix of tubular cation exchange membrane 21 contains a close fitting filament 22 (nylon monofilament fishing line). The coiled helix of tubular cation exchange membrane 21 is contained in a base compartment 23. Dilute base 24 (for example potassium hydroxide in water) is flowed into the base compartment 23 and then to waste by way of line 25. The membrane 21 is permeable to the base in the compartment 23 by “Donnan forbidden leakage”. Therefore, base is added to the suppressed eluant stream flowing through the membrane 21 to produce a base treated suppressed eluant stream that is flowed through a second conductivity detector 26. The elements 15-26 are contained in a thermostatic enclosure 27. The second electrical conductivity detector 26 determines the separated anions as a negative response from an elevated baseline response of the base treated suppressed eluant stream as shown in FIG. 3.

Referring again to FIG. 1, the combination of the coiled helix of tubular cation exchange membrane 21 and the filament 22 generates radial mixing of the base treated suppressed eluant. Said mixing is believed to be the reason why the noise level of the baseline response of the base treated suppressed eluant stream is less than one half the baseline noise level of a base treated suppressed eluant stream that is flowed through a reference membrane the same as the membrane 21 but which reference membrane is not coiled nor containing a filament.

Referring now to FIG. 1, therein is shown a preferred apparatus 40 for the determination of cations of interest in a sample to be analyzed. The apparatus 40 includes a reservoir 41 containing an eluant of dilute acid 42. The reservoir 41 is in fluid communication with a liquid chromatography pump 43 which pumps eluant 42 through a sample injection valve 45. A sample 46 containing cations of interest is contained in syringe 47 to be injected into the acidic eluant 42 by the injection valve 45. The cations of interest are separated by cation exchange chromatography on cation exchange chromatography column 48. An ion chromatography suppressor 49 exchanges the anions of the stream of separated cations from the column 48 for hydroxide ion to produce a suppressed eluant stream that is flowed through a first electrical conductivity detector 50. The first electrical conductivity detector 50 determines the separated cations as a positive response from a baseline response of the suppressed eluant stream.

The stream of suppressed eluant from the first conductivity detector 50 is then flowed through a coiled helix of tubular anion exchange membrane 51. The coiled helix of tubular anion exchange membrane 51 contains a close fitting filament 52 (nylon monofilament fishing line). The coiled helix of tubular anion exchange membrane 51 is contained in an acid compartment 53. Dilute acid 54 (for example hydrochloric acid in water) is flowed into the base compartment 53 and then to waste by way of line 55. The membrane 51 is permeable to the acid in the compartment 53 by “Donnan forbidden leakage”. Therefore, acid is added to the suppressed eluant stream flowing through the membrane 51 to produce an acid treated suppressed eluant stream that is flowed through a second conductivity detector 56. The elements 48-56 are contained in a thermostatic enclosure 57. The second electrical conductivity detector 56 determines the separated cations as a negative response from an elevated baseline response of the acid treated suppressed eluant stream.

The combination of the coiled helix of tubular anion exchange membrane 51 and the filament 52 is believed to generate radial mixing of the acid treated suppressed eluant. Said mixing is believed to be the reason why the noise level of the baseline response of the acid treated suppressed eluant stream will be less than one half the baseline noise level of an acid treated suppressed eluant stream that is flowed through a reference membrane the same as the membrane 51 but which reference membrane is not coiled nor containing a filament.

Referring now to FIG. 5, therein is shown a base addition device 60 that includes a base permeable tubular membrane 61. A plurality of particles 62 are positioned in the bore of the membrane 61 as mixing elements to mix the suppressed eluant flowed down the bore of the membrane 61. The membrane 61 is positioned in a base compartment 63. Base 64 is flowed into the compartment 63 and out line 65. The membrane 61 can be any membrane that is permeable to base such as a dialysis membrane, a porous membrane, an ion exchange membrane or a zwitterion membrane. The mixing element positioned in the bore of the membrane 61 can be any mixing element such as a chain, a configured filament or a plurality of shorter filaments.

Referring now to FIG. 6, therein is shown an acid addition device 70 that includes an acid permeable tubular membrane 71. A plurality of particles 72 are positioned in the bore of the membrane 71 as mixing elements to mix the suppressed eluant flowed down the bore of the membrane 71. The membrane 71 is positioned in an acid compartment 73. Acid 74 is flowed into the compartment 73 and out line 75. The membrane 71 can be any membrane that is permeable to acid such as a dialysis membrane, a porous membrane, an ion exchange membrane or a zwitterion membrane. The mixing element positioned in the bore of the membrane 71 can be any mixing element such as a chain, a configured filament or a plurality of shorter filaments.

Referring now to FIG. 7, therein is shown a device 80 for the addition of acid or base 80. The acid or base 81 is introduced into a flow channel 82 by way of line 83. The suppressed eluent 85 is flowed through the channel 82. A pluality of particles 84 in the channel 82 act as a mixing element. It will be noticed that the step of adding the acid or base 81 to the suppressed eluant is followed by the step of mixing the acid or base treated suppressed eluant.

Referring now to FIG. 8, therein is shown a device 90 for the addition of acid or base 90. The acid or base 91 is introduced into a helical tubular flow channel 92 by way of line 93. The suppressed eluent 95 is flowed through the channel 92. A filament 94 in the channel 92 act as a mixing element. It will be noticed that the step of adding the acid or base 91 to the suppressed eluant is followed by the step of mixing the acid or base treated suppressed eluant.

Referring now to FIG. 9, therein is shown a device 100 for the addition of acid or base 101. The acid or base 101 is introduced into a tightly configured tubular flow channel 102 by way of line 103. The suppressed eluant 105 is flowed through the channel 102. The tightly configured channel 102 acts as a mixing element. A tube can be tightly configured by, for example, knitting a tube or by tying a tube in a series of knots. It will be noticed that the step of adding the acid or base 101 to the suppressed eluant is followed by the step of mixing the acid or base treated suppressed eluant. For example, the effluent from a microelectrodialytic base generator used as a base addition device can be mixed by any suitable means such as the means shown in FIGS. 7-9.

Referring now to FIG. 10, therein is shown an acid or base addition device 110. The acid or base 111 is positioned on one side of an acid or base permeable planar membrane 112. The suppressed eluant 116 is flowed through a channel 113 defined by a body 114. A screen 115 of woven filament material is positioned adjacent the membrane 112 and acts as a mixing element to mix the acid or base treated suppressed eluant.

Referring now to FIG. 11, therein is shown an acid or base addition device 120. The acid or base 121 is positioned on one side of an acid or base permeable planar membrane 122. The suppressed eluant 126 is flowed through a channel 123 defined by a body 124. A plurality of particles 125 are positioned adjacent the membrane 122 and act as a mixing element to mix the acid or base treated suppressed eluant.

It will now be appreciated that the specific means used in the instant invention to add the acid or base to the suppressed eluant stream is not critical in the invention. Similarly, the specific means used to mix the acid or base treated suppressed eluant stream is not critical. In the absence of such mixing, it is believed that the only significant mechanism for mass transport in the direction radial of the direction of flow is diffusion. Such diffusion is a relatively slow process compared to physical mixing. It is believed that the reason the baseline noise of detection of weak acid anions (or weak base cations) can be reduced by a factor of at least two in the instant invention relative to the prior art is the mixing step and mixing elements of the instant invention.

What is claimed is:

1. A chemical analysis method for determining anions of interest in a sample to be analyzed, comprising the steps of: separating the anions of interest by anion exchange chromatography using a basic eluant to produce a stream of separated anions in the eluant; exchanging the cations of the stream of separated anions for hydrogen ion to produce a suppressed eluant stream; adding base to the suppressed eluant stream to produce a base treated suppressed eluant stream; mixing the base treated suppressed eluant stream; determining the electrical conductivity of the base treated suppressed eluant stream to determine the separated anions as a negative electrical conductivity response from a baseline response of the base treated suppressed eluant stream.

2. The method of claim 1, wherein the noise level of the baseline response of the base treated suppressed eluant stream is less than one half the baseline noise level of a base treated suppressed eluant stream that is not mixed.

3. The method of claims 1 and 2, wherein the mixing of the base treated suppressed eluant stream is accomplished by flowing the base treated suppressed eluant stream through a helical tube containing a filament.

4. The method of claim 3, wherein the tube comprises a base permeable membrane.

5. The method of claim 4, wherein the base permeable membrane is a cation exchange membrane.

6. The method of claims 1 and 2, wherein the mixing of the base treated suppressed eluant stream is accomplished by flowing the base treated suppressed eluant stream through a tube containing particles.

7. The method of claim 6, wherein the tube comprises a base permeable membrane.

8. The method of claim 7, wherein the base permeable membrane is a cation exchange membrane.

9. The method of claims 1 and 2, wherein the mixing of the base treated suppressed eluant stream is accomplished by flowing the base treated suppressed eluant stream through a configured tube.

10. The method of claims 1 and 2, wherein the mixing of the base treated suppressed eluant stream is accomplished by flowing the base treated suppressed eluant stream through a channel partitioned from a source of base by a base permeable membrane, the channel containing a mixing element.

11. The method of claim 10, wherein the mixing element is a screen.

12. The method of claim 10, wherein the mixing element is a plurality of particles.

13. The method of claims 10, 11 and 12, wherein the base permeable planar membrane is a cation exchange membrane.

14. The method of claims 1-13, further comprising the step of determining the electrical conductivity of the suppressed eluant stream to determine the separated anions as a positive electrical conductivity response from a baseline response of the suppressed eluant stream.

15. A chemical analysis method for determining cations of interest in a sample to be analyzed, comprising the steps of: separating the cations of interest by cation exchange chromatography using an acidic eluant to produce a stream of separated cations in the eluant; exchanging the anions of the stream of separated cations for hydroxide ion to produce a suppressed eluant stream; adding acid to the suppressed eluant stream to produce an acid treated suppressed eluant stream; mixing the acid treated suppressed eluant stream; determining the electrical conductivity of the acid treated suppressed eluant stream to determine the separated cations as a negative electrical conductivity response from a baseline response of the acid treated suppressed eluant stream.

16. The method of claim 15, wherein the noise level of the baseline response of the acid treated suppressed eluant stream is less than one half the baseline noise level of an acid treated suppressed eluant stream that is not mixed.

17. The method of claims 15 and 16, wherein the mixing of the acid treated suppressed eluant stream is accomplished by flowing the acid treated suppressed eluant stream through a helical tube containing a filament.

18. The method of claim 17, wherein the tube comprises an acid permeable membrane.

19. The method of claim 18, wherein the acid permeable membrane is an anion exchange membrane.

20. The method of claims 15 and 16, wherein the mixing of the acid treated suppressed eluant stream is accomplished by flowing the acid treated suppressed eluant stream through a tube containing particles.

21. The method of claim 20, wherein the tube comprises an acid permeable membrane.

22. The method of claim 21, wherein the acid permeable membrane is an anion exchange membrane.

23. The method of claims 15 and 16, wherein the mixing of the acid treated suppressed eluant stream is accomplished by flowing the acid treated suppressed eluant stream through a configured tube.

24. The method of claims 15 and 16, wherein the mixing of the acid treated suppressed eluant stream is accomplished by flowing the acid treated suppressed eluant stream through a channel partitioned from a source of acid by an acid permeable membrane, the channel containing a mixing element.

25. The method of claim 24, wherein the mixing element is a screen.

26. The method of claim 24, wherein the mixing element is a plurality of particles.

27. The method of claims 24, 25 and 26, wherein the acid permeable planar membrane is an anion exchange membrane.

28. The method of claims 15-27, further comprising the step of determining the electrical conductivity of the suppressed eluant stream to determine the separated cations as a positive electrical conductivity response from a baseline response of the suppressed eluant stream.

29. Apparatus for the chemical analysis of anions of interest in a sample to be analyzed, comprising: an anion exchange chromatography column; an ion chromatography suppressor in fluid communication with the anion exchange chromatography column; a base addition device in fluid communication with the ion chromatography suppressor; a mixer in fluid communication with the base addition device; an electrical conductivity detector in fluid communication with the mixer.

30. The apparatus of claim 29, wherein the mixer is a helical tube containing a filament.

31. The apparatus of claim 30, wherein the tube comprises a base permeable membrane.

32. The apparatus of claim 31, wherein the base permeable membrane is a cation exchange membrane.

33. The apparatus of claim 29, wherein the mixer is a tube containing a plurality of particles.

34. The apparatus of claim 33, wherein the tube comprises a base permeable membrane.

35. The apparatus of claim 34, wherein the base permeable membrane is a cation exchange membrane.

36. The apparatus of claim 29, wherein the mixer is a configured tube.

37. The apparatus of claim 29, wherein the mixer is a screen positioned in a flow channel adjacent a base permeable planar membrane.

38. The apparatus of claim 37, wherein the base permeable planar membrane is a cation exchange membrane.

39. The apparatus of claim 29, wherein the mixer is a plurality of particles in a flow channel adjacent a base permeable planar membrane.

40. The apparatus of claim 39, wherein the base permeable planar membrane is a cation exchange membrane.

41. The apparatus of claims 29-40, further including an additional electrical conductivity detector in fluid communication with the ion chromatography suppressor and the base addition device.

42. Apparatus for the chemical analysis of cations of interest in a sample to be analyzed, comprising: a cation exchange chromatography column; an ion chromatography suppressor in fluid communication with the anion exchange chromatography column; an acid addition device in fluid communication with the ion chromatography suppressor; a mixer in fluid communication with the acid addition device; an electrical conductivity detector in fluid communication with the mixer.

43. The apparatus of claim 42, wherein the mixer is a helical tube containing a filament.

44. The apparatus of claim 43, wherein the tube comprises an acid permeable membrane.

45. The apparatus of claim 44, wherein the acid permeable membrane is an anion exchange membrane.

46. The apparatus of claim 42, wherein the mixer is a tube containing a plurality of particles.

47. The apparatus of claim 46, wherein the tube comprises an acid permeable membrane.

48. The apparatus of claim 47, wherein the acid permeable membrane is an anion exchange membrane.

49. The apparatus of claim 42, wherein the mixer is a configured tube.

50. The apparatus of claim 42, wherein the mixer is a screen positioned in a flow channel adjacent an acid permeable planar membrane.

51. The apparatus of claim 50, wherein the acid permeable planar membrane is an anion exchange membrane.

52. The apparatus of claim 42, wherein the mixer is a plurality of particles in a flow channel adjacent an acid permeable planar membrane.

53. The apparatus of claim 52, wherein the acid permeable planar membrane is an anion exchange membrane.

54. The apparatus of claims 42-53, further including an additional electrical conductivity detector in fluid communication with the ion chromatography suppressor and the acid addition device.
